(19) United States
(12) Patent Application Publication
(10) Pub. No.: US 2021/0283892 A1
(43) Pub. Date: Sep. 16, 2021

(54) MANUFACTURING METHOD OF LAMINATE FOR MANUFACTURING FUEL CELL

(71) Applicant: TOYOTA JIDOSHA KABUSHIKI KAISHA, Toyota-shi (JP)

(72) Inventors: Teppei IKEDA, Nagoya-shi (JP); Tatsuya ASAI, Miyoshi-shi (JP); Kazuya OTSU, Miyoshi-shi (JP)

(73) Assignee: TOYOTA JIDOSHA KABUSHIKI KAISHA, Toyota-shi (JP)

(21) Appl. No.: 17/197,795

(22) Filed: Mar. 10, 2021

(30) Foreign Application Priority Data
Mar. 12, 2020 (JP) 2020-042879

(51) Int. Cl. B32B 37/00; B32B 7/06; B32B 37/06; B32B 37/10; B32B 37/20; B32B 38/10; B32B 38/00; H01M 8/1004

(52) U.S. Cl. CPC B32B 37/025; H01M 2008/1095; B32B 37/06; B32B 37/10; B32B 37/20; B32B 38/10; B32B 38/1875; H01M 8/1004; B32B 2250/03; B32B 2307/202; B32B 2307/724; B32B 2309/02; B32B 2309/16; B32B 2457/18; B32B 7/06

(57) ABSTRACT

A manufacturing method of a laminate for manufacturing a fuel cell which uses a roll-to-roll technique includes: a first step of preparing a first laminate formed by stacking the release layer, the electrolyte membrane and an electrode layer in this order on a back sheet, a second step of stacking and bonding a gas diffusion layer on the electrode layer of the first laminate to obtain a second laminate, and a third step of peeling the back sheet from the second laminate to obtain a third laminate; and the bonding temperature in the second step is less than 170° C., and a tension X (N) applied to the back sheet, and a conveyance speed Y (m/min) at which the second step to the third step are continuously executed satisfy a following equation (1).

Y≤12.09exp (−0.15X) . . . (1).

### CROSS REFERENCE TO RELATED APPLICATIONS

This application claims priority to Japanese Patent Application No. 2020-042879, filed Mar. 12, 2020, the disclosure of which is incorporated by reference herein in its entirety.

### BACKGROUND

### Field

The present disclosure relates to a manufacturing method of a laminate for manufacturing a fuel cell.

### Related Art

A method which uses a roll-to-roll technique is known as a method for manufacturing a laminate including an electrolyte membrane and a catalyst electrode layer which make up a fuel cell. For example, JP2018-045842A discloses a method for pasting an MEA sheet which makes up a membrane electrode assembly to a GDL sheet which makes up a gas diffusion layer by heat pressure treatment, and then executing a peeling process of peeling a back sheet from the MEA sheet. According to JP2018-045842A, the temperature and the pressure at the time of the heat pressure treatment are increased at a start end portion in a drawing direction of the MEA sheet more so than in other portions to enhance adhesion between the start end portion of the MEA sheet and the GDL sheet, and to suppress the MEA sheet from adhering to the back sheet side in the peeling process.

Patent Literature 1: JP2018-045842A

As a method for manufacturing a laminate for manufacturing a fuel cell including an electrolyte membrane, the inventors of this application are studying a method different from the method of JP2018-045842A; specifically, a method for forming on a back sheet a laminate obtained by forming a catalyst electrode layer on only one surface of the electrolyte membrane such that the other surface of the electrolyte membrane and the back sheet are in contact, pasting a gas diffusion layer on the catalyst electrode layer by heat pressure treatment, and then peeling the back sheet from the electrolyte membrane. According to this method, it is preferable to provide a release layer including a release agent between the back sheet and the electrolyte membrane to make it easy to peel the back sheet. However, the inventors of this application have newly found that, depending on conditions at the time of manufacturing, there is a problem in that part of the release layer, which needs to remain on the back sheet, adheres to the electrolyte membrane in the peeling process.

### SUMMARY

In one aspect of the present disclosure, there is provided a manufacturing method of a laminate for manufacturing a fuel cell by a roll-to-roll technique, the laminate being formed by stacking an electrolyte membrane, an electrode layer and a gas diffusion layer. This manufacturing method of the laminate for manufacturing the fuel cell includes: a first step of preparing a first laminate formed by stacking the release layer, the electrolyte membrane and the electrode layer in this order on a back sheet; a second step of stacking the gas diffusion layer on the electrode layer of the first laminate, and bonding the first laminate and the gas diffusion layer by heating and pressurizing to obtain a second laminate; and a third step of peeling the back sheet from the second laminate to obtain a third laminate, and a bonding temperature which is less than 170° C. when the first laminate and the gas diffusion layer are bonded in the second step, and a tension X (N) to be applied to the back sheet peeled in the third step, and a conveyance speed Y (m/min) at which the second step to the third step are continuously executed satisfy the following equation (1).

Y≤12.09exp (−0.15X) . . . (1)

### BRIEF DESCRIPTION OF THE DRAWINGS

FIG. 1 is a cross-sectional schematic view illustrating a schematic configuration of a unit cell;

FIG. 2 is a flowchart illustrating a manufacturing method of a laminate for manufacturing a fuel cell;

FIG. 3 is an explanatory view illustrating part of a manufacturing process of the laminate for manufacturing the fuel cell;

FIG. 4 is an explanatory view illustrating an enlarged state of a third step;

FIG. 5 is an explanatory view illustrating the enlarged state of the third step;

FIG. 6 is an explanatory view illustrating a result obtained by variously changing manufacturing conditions and manufacturing a third laminate;

FIG. 7 is a scatter diagram in which values of a conveyance speed Y and a bonding temperature of each sample are plotted; and

FIG. 8 is a scatter diagram in which values of a BS tension X and the conveyance speed Y of each sample are plotted.

### DETAILED DESCRIPTION

### A. Configuration of Fuel Cell

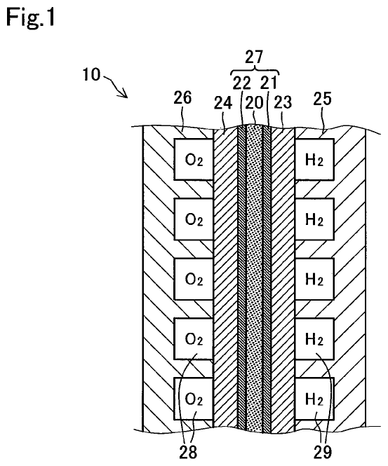

FIG. 1 is a cross-sectional schematic view illustrating a schematic configuration of a unit cell 10 which makes up a fuel cell according to an embodiment of the present disclosure. The fuel cell according to the present embodiment is a solid polymer fuel cell which generates power when receiving a supply of a fuel gas containing hydrogen and an oxidizing gas containing oxygen. The fuel cell is formed by stacking a plurality of unit cells 10.

The unit cell 10 includes a structure formed by stacking a Membrane Electrode Assembly (MEA) 27, gas diffusion layers 23 and 24 and gas separators 25 and 26. The MEA 27 includes an electrolyte membrane 20, and an anode 21 and cathode 22 which are catalyst electrode layers. The anode 21, the electrolyte membrane 20 and the cathode 22 are stacked in this order. The gas diffusion layer 23 is provided on the anode 21 of the MEA 27, and the gas separator 25 is arranged on the gas diffusion layer 23. Furthermore, the gas diffusion layer 24 is provided on the cathode 22 of the MEA 27, and the gas separator 26 is arranged on the gas diffusion layer 24.

The electrolyte membrane 20 is an ion exchange membrane which is formed with a polymer electrolyte material, has proton conductivity, and shows good electrical conductivity in a wet state. According to the present embodiment, a membrane made of a perfluorosulfonic acid polymer which is a fluorine-based resin having a sulfo group (—SO₃ group) at a side chain end is used as the electrolyte membrane 20.

The cathode 22 and the anode 21 include carbon particles which carry a catalyst metal which promotes an electrochemical reaction, and a polymer electrolyte which has proton conductivity. For example, platinum or a platinum alloy which consists of platinum and another metal, such as ruthenium, can be used as the catalyst metal. As another example, a perfluorosulfonic acid polymer which has a sulfo group (—SO₃ group) at a side chain end can be used as the polymer electrolyte. The polymer electrolyte included in the catalyst electrode layer may be the same type of polymer as the polymer electrolyte which makes up the electrolyte membrane 20, or may be a different type of polymer.

The gas diffusion layers 23 and 24 are made up by members which have gas permeability and electron conductivity. According to the present embodiment, the gas diffusion layers 23 and 24 are formed by a carbon member such as carbon cloth or carbon paper. A Micro Porous Layer (MPL) which includes finer pores than those of the other portions of the gas diffusion layers 23 and 24 and has enhanced water repellency may be provided on a surface of at least one of the gas diffusion layers 23 and 24 on a side which is in contact with the catalyst electrode layer.

The gas separators 25 and 26 are formed by a gas impermeable conductive member such as a carbon member, for instance, dense carbon whose carbon is compressed to realize gas impermeability, or a metal member such as press-molded stainless steel. Flow path grooves 28 and 29 in which a reactive gas (a fuel gas or an oxidizing gas) flows are formed on surfaces of the gas separators 25 and 26 facing the gas diffusion layers 23 and 24. In addition, a porous body for forming an intra-cell gas flow path may be arranged between the gas separators 25 and 26 and the gas diffusion layers 23 and 24. In this case, the flow path grooves 28 and 29 may be omitted.

### B. Manufacturing Method of Laminate for Manufacturing Fuel Cell

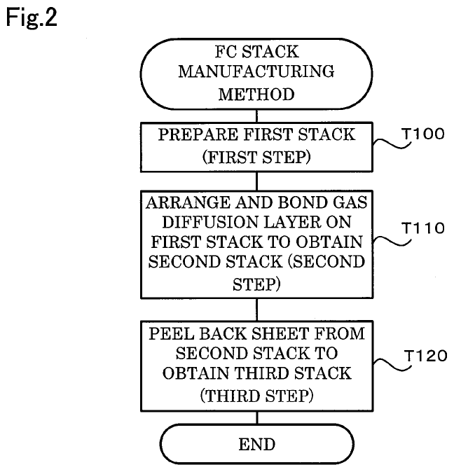

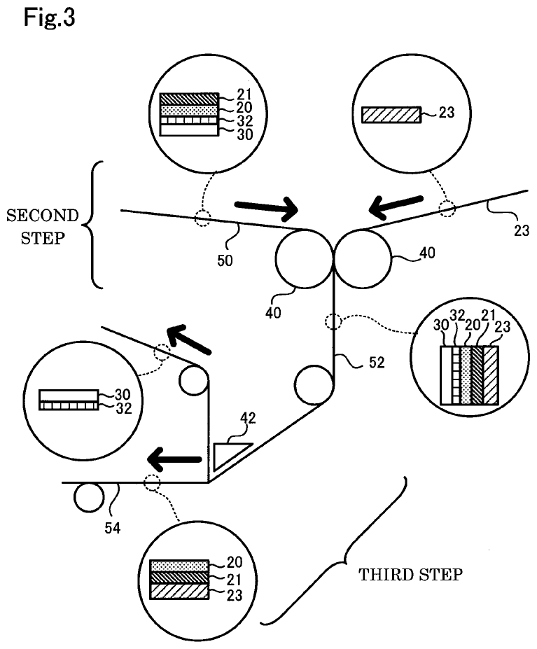

FIG. 2 is a flowchart illustrating a method for manufacturing a third laminate 54 which is a laminate for manufacturing a fuel cell according to the present embodiment. Furthermore, FIG. 3 is an explanatory view illustrating part of a manufacturing process of the third laminate 54. According to the present embodiment, each layer which makes up the third laminate 54 is continuously conveyed by a roll-to-roll technique to manufacture the third laminate 54. FIG. 3 illustrates directions in which each layer is conveyed with arrows. The method for manufacturing the third laminate 54 will be described below based on FIG. 2 with reference to FIG. 3.

To manufacture the third laminate 54, a first laminate 50 is prepared first in a first step (step T100). The first laminate 50 is formed by stacking a release layer 32, the electrolyte membrane 20 and the anode 21 which is the catalyst electrode layer in this order on the back sheet 30. FIG. 3 illustrates that the first laminate 50 is made up by the above-described four layers.

The back sheet 30 only needs to have the strength for enduring the processes performed until the back sheet 30 is peeled in a third step described below, and heat resistance for enduring heating in a second step described below, and can be formed by, for example, a resin material. More specifically, the back sheet 30 can be made of a resin selected from, for example, polyethylene terephthalate (PET), polytetrafluoroethylene (PTFE), perfluoroalkoxy alkane (PFA), polyethylene, polypropylene, polyimide, syndiotactic polystyrene (SPS), polyetheretherketone (PEEK), polyamide, or polyvinylidene fluoride (PVDF). From the viewpoint that it is easy to secure adhesion to the release layer 32, polyethylene terephthalate (PET) is used as the resin material which makes up the back sheet 30 in the present embodiment.

The release layer 32 is a layer which includes a release agent. In the present embodiment, a cyclic olefin copolymer (COC) is used as the release agent. The release layer 32 is provided to make it easy to perform an operation of peeling the third laminate 54 from the back sheet 30 in the third step described below. The release layer 32 may include a layer which mainly includes the release agent, and may further include a layer (adhesive layer) which mainly includes an adhesive which is a material more compatible with the back sheet 30 than the release agent, between the layer which mainly includes this release agent and the back sheet 30. The release layer 32 includes the adhesive layer, so that it is possible to enhance adhesion between the release layer 32 and the back sheet 30. For example, polyvinylidene chloride (PVDC) can be used as the above-described adhesive. The layer which mainly includes the release agent and the adhesive layer only need to be formed as a layer in which at least part of the layer and the adhesive layer are mixed in the release layer 32. This release layer 32 can be formed by preparing each the adhesive and the release agent in a state where they are heated and melted or in a state where they are melted in a solvent, and applying the adhesive and the release agent in this order onto the back sheet 30.

When the first laminate 50 formed by stacking the electrolyte membrane 20 and the anode 21 in this order with the release layer 32 interposed therebetween on the back sheet 30 is prepared in step T100, the gas diffusion layer 23 is next stacked on the anode 21 of this first laminate 50, and the first laminate 50 and the gas diffusion layer 23 are bonded by heating and pressurizing to obtain a second laminate 52 (step T110). Step T110 is also referred to as a second step. FIG. 3 illustrates a state where the first laminate 50 and the gas diffusion layer 23 are hot-pressed using a hot bonding roll 40 to obtain the second laminate 52. The temperature conditions in step T110 will be described later.

When the second laminate 52 is obtained by hot-pressing in step T110, the back sheet 30 is then peeled together with the release layer 32 from the second laminate 52 to obtain the third laminate 54 which is a laminate for manufacturing a fuel cell (step T120). Step T120 is also referred to as a third step. FIG. 3 illustrates a state where the back sheet 30 is peeled from the second laminate 52 by a peel bar 42. In this case, a preset tension is applied to the back sheet 30. Conditions relative to the tension to be applied to the back sheet 30 will be described later.

When the third laminate 54 is obtained in step T120, the cathode 22 and the gas diffusion layer 24 are further stacked in this order on the electrolyte membrane 20 of the third laminate 54, and the obtained laminate is further cut into a size which is suitable to the unit cell 10. Furthermore, by sandwiching the cut laminate between the gas separators 25 and 26, it is possible to obtain the unit cell 10.

According to the method for manufacturing the third laminate 54 (laminate for manufacturing fuel cell) of the present embodiment, a bonding temperature (also referred to simply as “bonding temperature” below), at which the first laminate 50 and the gas diffusion layer 23 are bonded in the second step (step T110), is less than 170° C. The bonding temperature is a set temperature of the hot bonding roll 40. Furthermore, according to the method for manufacturing the third laminate 54 of the present embodiment, a conveyance speed Y (whose unit is m/min, and which is also referred to as a “conveyance speed Y” below) of a workpiece at which the second step (step T110) to the third step (step T120) are continuously executed, and a tension X (whose unit is N, and which is also referred to as a “BS tension X” below) to be applied to the back sheet 30 which is peeled in the third step (step T120) satisfy the following equation (1).

Y≤12.09exp (−0.15X) . . . (1)

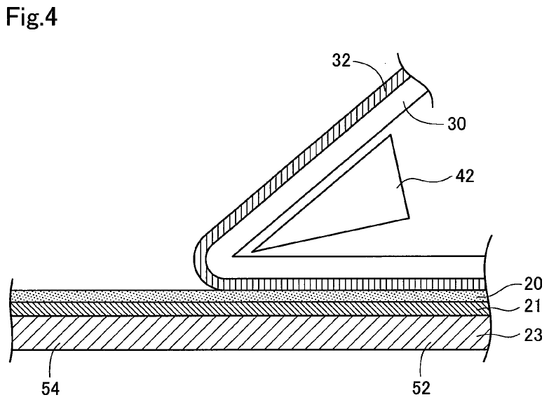

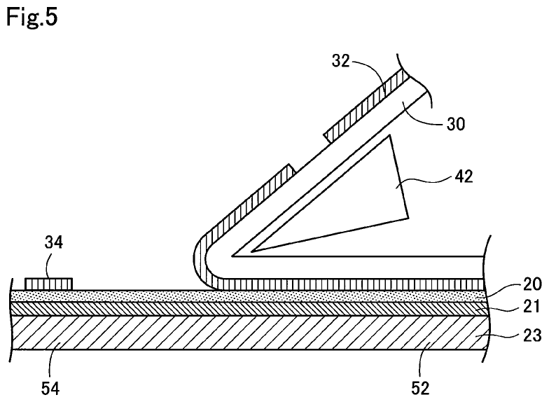

FIGS. 4 and 5 are explanatory views illustrating an enlarged state where the back sheet 30 is peeled from the second laminate 52 in the third step. FIG. 4 illustrates a state where the above peeling in the third step was performed normally. When peeling is performed normally, the release layer 32 remains on the side of the back sheet 30. FIG. 5 illustrates a state where the above peeling in the third step was not performed normally. FIG. 5 illustrates a state where a transfer portion 34 which is part of the release layer 32 adheres onto the electrolyte membrane 20 of the third laminate 54 without being peeled together with the back sheet 30 as a state where peeling was not performed normally. According to the present embodiment, the BS tension X, the conveyance speed Y, and the bonding temperature, which are conditions relative to the second and third step; are set as described above to make it possible to peel the back sheet 30 in the third step well. Below is a description of the relationship between whether peeling of the back sheet 30 in the third step succeeds or fails, and the above conditions relative to the second and third step.

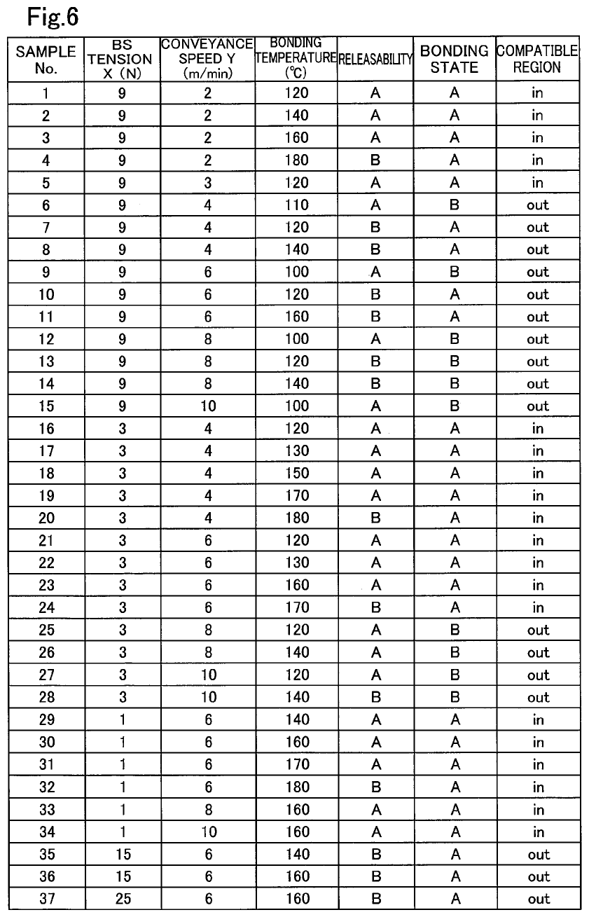

FIG. 6 is an explanatory view illustrating a result obtained by variously changing the BS tension X, the conveyance speed Y, and the bonding temperature, and manufacturing the third laminate 54 by the manufacturing method illustrated in the flowchart in FIG. 2. FIG. 6 illustrates a result obtained by evaluating the “releasability” and the “bonding state” of the obtained third laminate 54 together with each of the above conditions set per sample. In FIG. 6, sample 1 to sample 15 are samples whose BS tensions X are 9N and are mutually common and whose conveyance speeds Y and bonding temperatures variously differ. A Sample 16 to sample 28 are samples whose BS tensions X are 3N and are mutually common, and whose conveyance speeds Y and bonding temperatures variously differ. Sample 29 to sample 34 are samples whose BS tensions X are 1N and are mutually common, and whose conveyance speeds Y and bonding temperatures variously differ. The BS tensions X of samples 35 and 36 are 15N. The BS tensions X of a sample 37 is 25N.

The evaluation result of “releasability” is a result obtained by checking whether peeling of the back sheet 30 in the third step succeeds or fails. More specifically, the releasability was evaluated by manufacturing the third laminate 54 by using the device illustrated in FIG. 3, and visually observing the surface of the electrolyte membrane 20 of the obtained belt-shaped third laminate 54 over a distance of 20 m in length. When even one portion of the release layer 32 was observed to have adhered onto the electrolyte membrane 20 of the third laminate 54, the releasability was determined to be poor, and evaluated as “B”. When no portions of the release layer 32 were observed to have adhered onto the electrolyte membrane 20 of the third laminate 54, the releasability was determined to be good, and evaluated as “A”.

The evaluation result of the “bonding state” is a result obtained by checking the bonding state between the electrolyte membrane 20, the anode 21 and the gas diffusion layer 23 after the third step. More specifically, the bonding state was evaluated by manufacturing the third laminate 54 by using the device illustrated in FIG. 3, and visually observing the surface of the electrolyte membrane 20 of the obtained belt-shaped third laminate 54 over a distance of 20 m in length. When even one wrinkle of 1 mm or more in length, which indicates a partial bonding failure of the electrolyte membrane 20, was observed on the electrolyte membrane 20 of the third laminate 54, the bonding state was determined to be poor, and evaluated as “B”. When the above wrinkle was not observed on the electrolyte membrane 20 of the third laminate 54, the bonding state was determined to be good, and evaluated as “A”.

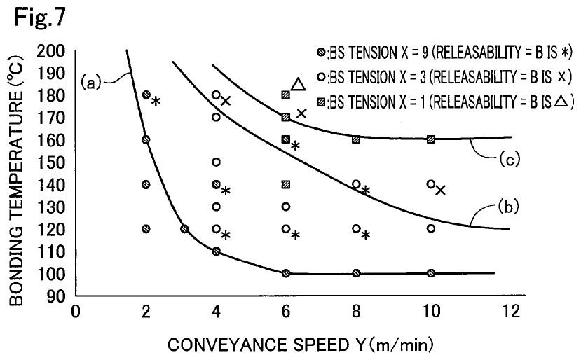

FIG. 7 is a scatter diagram in which the horizontal axis is the conveyance speed Y, the vertical axis is the bonding temperature, and values of each sample illustrated in FIG. 6 are plotted. FIG. 7 distinguishes between and illustrates a sample whose BS tension X is 9N, a sample whose BS tension X is 3N, and a sample whose BS tension X is 1N. Furthermore, in FIG. 7, points at which the releasability evaluation result is “B” are respectively assigned marks illustrated in FIG. 7.

As illustrated in FIG. 7, upon comparison between samples whose BS tensions X are the same, it is found that, the lower the conveyance speed Y and the lower the bonding temperature, the more likely the releasability evaluation result will be good (“A”). FIG. 7 illustrates a graph which connects the upper limits of the joining temperatures at which the releasability evaluation result is good (“A”) with the transport speed Y for each BS tension X. The graph which connects the above upper limits of the sample whose BS tension X is 9N is a graph (a), the graph which connects the above upper limits of the sample whose BS tension X is 3N is a graph (b), and the graph which connects the above upper limits of the sample whose BS tension X is 1N is a graph (c). It was found based on the results obtained by comparing these upper limit graphs (a) to (c) that, in a case where a specific bonding temperature was set, the greater the BS tension X, the lower the upper limit value of the conveyance speed Y at which the releasability evaluation result was good “A”.

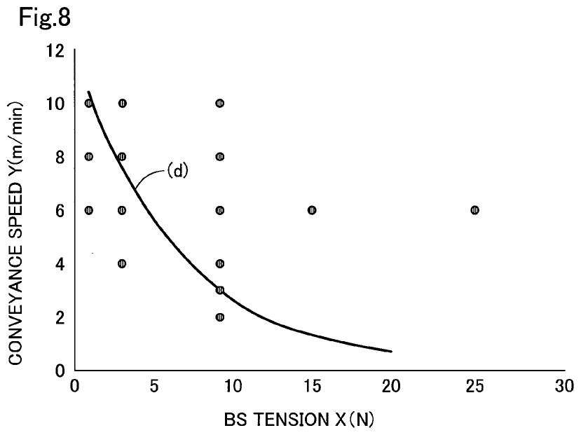

FIG. 8 is a scatter diagram in which the horizontal axis is the BS tension X, the vertical axis is the conveyance speed Y, and in which the values of each sample illustrated in FIG. 6 are plotted. Furthermore, in FIG. 8, a graph according to following equation (2) is illustrated together therein as graph (d). Equation (2) is an approximation which approximates the relationship between values of the BS tensions X and the conveyance speeds Y of the samples 5, 25, 26 and 34 as an exponential function. In FIG. 8, a region on a lower side than graph (d) of equation (2), i.e., a region which satisfies the above-described equation (1) is also referred to as a “compatible region”.

Y=12.09exp(−0.15X) . . . (2)

In FIG. 6, samples whose combinations of BS tension X and conveyance speed Y are included in the above “compatible region” are listed as “in” in the “compatible region” column. Samples whose combinations of BS tension X and conveyance speed Y are not included in the above “compatible region” listed as “out” in the “compatible region” column. The combinations of the BS tension X and the conveyance speed Y satisfy equation (1) as illustrated in FIGS. 6 and 8, so that releasability improves in a wide temperature range of the bonding temperature.

However, even when the combinations of the BS tension X and the conveyance speed Y satisfy equation (1), it is preferable to make the bonding temperature less than 170° C. to improve releasability. Although, for example, the combinations of the BS tension X and the conveyance speed Y of the samples 4, 20, 24 and 32 in FIG. 6 satisfy equation (1), the bonding temperatures are 170° C. or more, and their releasability evaluation results are “B”. It is thought that, in the first laminate 50 prepared in the first step (step T100), the above-described release agent or adhesive which makes up the release layer 32 enters fine recesses and protrusions such as scratches, etc. on the surface of the back sheet 30, and a so-called anchor effect enhances adhesion between the back sheet 30 and the release layer 32. It is thought that, the higher the bonding temperature at the time of hot-pressing in the second step (step T110), the more the release agent or the adhesive softened at the time of hot-pressing, the more the above anchor effect decreases, and the lower the adhesion between the back sheet 30 and the release layer 32. When the adhesion between the back sheet 30 and the release layer 32 lowers at the time of hot-pressing, part of the release layer 32 adheres to the side of the electrolyte membrane 20 in the third step, and the releasability is likely to decrease. Therefore, according to the present embodiment, the bonding temperature is set to less than 170° C. to suppress a decrease in the adhesion between the back sheet 30 and the release layer 32, and to improve the releasability.

According to the method for manufacturing the laminate for manufacturing the fuel cell (third laminate) of the present embodiment formed as described above, when the gas diffusion layer 23 is bonded by hot-pressing onto the anode 21 of the first laminate 50 formed by stacking the release layer 32, the electrolyte membrane 20 and the anode 21 in this order on the back sheet 30, and then the back sheet 30 is peeled to obtain the third laminate 54, the bonding temperature at the time of hot-pressing is less than 170° C., and the BS tension X and the conveyance speed Y satisfy equation (1). Consequently, it is possible to suppress at least part of the release layer 32 (which should remain on the back sheet 30), from adhering to the electrolyte membrane 20 in the third step (step T120) of peeling the back sheet 30, and improve releasability.

When a fuel cell is manufactured by using the third laminate 54 with part of the release layer 32 adhered onto the electrolyte membrane 20, the release layer 32 is present between the electrolyte membrane 20 and the cathode 22, and therefore there is a possibility that the performance of the fuel cell will be lowered. To suppress this decrease in the performance of the fuel cell, a countermeasure is conceivable wherein the part to which the release layer 32 adheres in the third laminate 54, wherein part of the release layer 32 is adhered onto the electrolyte membrane 20, is excluded from a target used for manufacturing the unit cell 10. However, production efficiency of the fuel cell may decrease in this case. According to the present embodiment, by suppressing adhesion of the release layer 32 to the electrolyte membrane 20, it is possible to enhance productivity of the fuel cell manufactured by using the third laminate 54.

In this regard, it is thought that, the slower the conveyance speed Y, the more likely that the time of hot-pressing in the second step becomes longer, and the easier it is to improve the bonding state between the electrolyte membrane 20 and the gas diffusion layer 23 with the anode 21 interposed therebetween. Furthermore, it is thought that, the faster the conveyance speed Y, the stronger the shear stress applied from the peel bar 42 to the second laminate 52 in the third step, and the more easily the back sheet 30 and the release layer 32 are peeled, and therefore releasability is more likely to decline.

Furthermore, it is thought that, the greater the BS tension X, the more likely that the bending stress increases at a part at which the second laminate 52 comes into contact with the peel bar 42 in the third step, the more easily the back sheet 30 and the release layer 32 are peeled, and therefore releasability is more likely to decline. Furthermore, it is thought that, the lesser the BS tension X, the less the stress produced at a part at which the second laminate 52 comes into contact with the peel bar 42 in the third step, suppressing the release layer 32 being peeled from the back sheet 30, so that releasability is likely to increase.

According to the method for manufacturing the laminate for manufacturing the fuel cell (third laminate) of the present embodiment, as described above, the bonding temperature is less than 170° C., and the BS tension X and the conveyance speed Y satisfy equation (1) as described above. As a result, by enhancing the bonding strength between the back sheet 30 and the release layer 32, or suppressing the release layer 32 from being peeled from the back sheet 30 in the third step, it is possible to improve releasability.

In addition, the bonding temperature in the second step is preferably higher than 110° C., is more preferably 120° C. or more, and is still more preferably 140° C. or more. By doing so, it is possible to enhance the bonding strength for bonding the first laminate 50 and the gas diffusion layer 23 in the second step, and improve the above-described bonding state after peeling of the back sheet 30 in the third step, i.e., the bonding state of the electrolyte membrane 20 and the gas diffusion layer 23 with the anode 21 interposed therebetween. However, the bonding temperature may be 110° C. or less. In this case, to secure the bonding strength of the electrolyte membrane 20 and the gas diffusion layer 23 with the anode 21 interposed therebetween, it is preferable to set a slower conveyance speed Y in, for example, a range in which the BS tension X and the conveyance speed Y satisfy equation (1).

When the BS tension is increased, it is more probable that the peel bar 42 shaves the back sheet 30 in the third step. Hence, from a viewpoint of suppressing such inconvenience, it is preferable to make the BS tension X 15N or less. Furthermore, when the BS tension X is decreased, accuracy of an operation of peeling the back sheet 30 in the third step or accuracy in setting the BS tension X is may be decreased. Hence, from a viewpoint of suppressing such inconvenience, it is preferable to make the BS tension X 1N or more. However, if the above inconvenience is allowable, the BS tension X may exceed 15N, or may be less than 1N.

When the conveyance speed Y is increased, it is likely that the time of hot-pressing in the second step is shortened, and the bonding strength between the electrolyte membrane 20 and the gas diffusion layer 23 with the anode 21 interposed therebetween becomes insufficient. Hence, from a viewpoint of securing bonding strength between the electrolyte membrane 20 and the gas diffusion layer 23 with the anode 21 interposed therebetween, it is preferable to make the conveyance speed Y 10 m/min or less. Furthermore, when the conveyance speed Y is slowed, it is possible that productivity of the third laminate 54 declines, and accuracy in setting the conveyance speed Y declines. Hence, from a viewpoint of suppressing such an inconvenience, the conveyance speed Y is preferably 0.1 m/min or more, is more preferably 0.2 m/min or more, and is still more preferably 0.5 m/min or more. However, if the above-described inconvenience is allowable, the conveyance speed Y may exceed 10 m/min, or may be less than 0.1 m/min.

In addition, in a case where the BS tension X and the conveyance speed Y are set to satisfy equation (1), the lower the BS tension X, the more possible to make the conveyance speed Y faster, and further enhance productivity of the third laminate 54. Hence, from a viewpoint of making it easy to enhance the productivity of the third laminate 54, it is preferable to make the BS tension X, for example, 3N or less.

The higher the bonding pressure of the hot bonding roll 40 in the second step (step T110), the more likely the bonding strength of the first laminate 50 and the gas diffusion layer 23 is to increase. Therefore, from such a viewpoint, it is preferable to make the above bonding pressure 2 kN or more, and is more preferable to make the above bonding pressure 3 kN or more. Furthermore, the lower the bonding pressure of the hot bonding roll 40, the more possible it is to suppress the force applied to the first laminate 50 and the gas diffusion layer at the time of bonding. Therefore, from such a viewpoint, it is preferable to make the above bonding pressure 8 kN or less, and it is more preferable to make the above bonding pressure 7 kN or less. Furthermore, according to the present embodiment, the peeling angle is set within a range of 90° to 160° in the third step (step T120). The peeling angle refers to an angle formed between the third laminate 54 and the back sheet 30 after peeling during a peeling operation of the peel bar 42 illustrated in FIG. 4.

### C. Other Embodiment

According to the above embodiment, the first laminate 50 includes the anode 21, and the gas diffusion layer 23 is bonded onto the anode 21 in the second step, yet it may employ a different configuration. The first laminate 50 prepared in the first step may include the cathode 22 instead of the anode 21, and the gas diffusion layer 24 may be bonded onto the cathode 22 in the second step. Even when this configuration is employed, it is possible to achieve the same effect as the effect of the embodiment by setting the bonding temperature in the second step to less than 170° C. and making the BS tension X and the conveyance speed Y satisfy equation (1).

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) According to one aspect of the present disclosure, there is provided a manufacturing method of a laminate for manufacturing a fuel cell by a roll-to-roll technique, the laminate being formed by stacking an electrolyte membrane, an electrode layer and a gas diffusion layer. This manufacturing method of the laminate for manufacturing the fuel cell includes: a first step of preparing a first laminate formed by stacking the release layer, the electrolyte membrane and the electrode layer in this order on a back sheet; a second step of stacking the gas diffusion layer on the electrode layer of the first laminate, and bonding the first laminate and the gas diffusion layer by heating and pressurizing to obtain a second laminate; and a third step of peeling the back sheet from the second laminate to obtain a third laminate, and a bonding temperature which is less than 170° C. when the first laminate and the gas diffusion layer are bonded in the second step, and a tension X (N) to be applied to the back sheet peeled in the third step, and a conveyance speed Y (m/min) at which the second step to the third step are continuously executed satisfy the following equation (1).

Y≤12.09exp (−0.15X) . . . (1)

According to the manufacturing method of the laminate for manufacturing the fuel cell of this aspect, when the gas diffusion layer is bonded onto the electrode layer of the first laminate formed by stacking the release layer, the electrolyte membrane and the electrode layer in this order on the back sheet, and then the back sheet is peeled to obtain the third laminate, the bonding temperature is less than 170° C., and the tension X and the conveyance speed Y satisfy equation (1). Consequently, it is possible to suppress at least part of the release layer from adhering to the surface of the electrolyte membrane of the third laminate after the third step of peeling the back sheet is finished.

(2) According to the manufacturing method of the laminate for manufacturing the fuel cell of the aforementioned aspect, the bonding temperature may be higher than 110° C.

According to the manufacturing method of the laminate for manufacturing the fuel cell of this aspect, it is possible to enhance bonding strength of the first laminate and the gas diffusion layer, and improve the bonding state of the electrolyte membrane, the electrode layer and the gas diffusion layer after the back sheet is peeled in the third step.

(3) According to the manufacturing method of the laminate for manufacturing the fuel cell of the above aspect, the tension X may be 3N or less.

According to the manufacturing method of the laminate for manufacturing the fuel cell of this aspect, it is possible to increase the conveyance speed Y, and enhance productivity of the laminate for manufacturing the fuel cell.

The present disclosure can be realized as various aspects. For example, the present disclosure can be realized as aspects such as a laminate for manufacturing a fuel cell which is manufactured by the manufacturing method of the laminate for manufacturing the fuel cell according to the above aspect, a fuel cell which includes this laminate, a fuel cell manufacturing method which includes each step of the manufacturing method of the laminate according to the above aspect, and a laminate manufacturing apparatus which includes a processor which supports each step of the laminate manufacturing method according to the above aspect.

What is claimed is:

1. A manufacturing method of a laminate for manufacturing a fuel cell by a roll-to-roll technique, the laminate being formed by stacking an electrolyte membrane, an electrode layer and a gas diffusion layer, the manufacturing method of the laminate for manufacturing the fuel cell comprising:
preparing a first laminate formed by stacking a release layer, the electrolyte membrane and the electrode layer in this order on a back sheet;
stacking the gas diffusion layer on the electrode layer of the first laminate, and bonding the first laminate and the gas diffusion layer by heating and pressurizing to obtain a second laminate; and
peeling the back sheet from the second laminate to obtain a third laminate,
wherein a bonding temperature at which the first laminate and the gas diffusion layer are bonded in the bonding is less than 170° C., and
wherein a tension X (N) to be applied to the back sheet peeled in the peeling, and a conveyance speed Y (m/min) at which the bonding to the peeling are continuously executed satisfy a following equation (1).
Y≤12.09exp (−0.15X) . . . (1)

2. The manufacturing method of the laminate for manufacturing the fuel cell according to claim 1, wherein the bonding temperature is higher than 110° C.

3. The manufacturing method of the laminate for manufacturing the fuel cell according to claim 1, wherein the tension X is 3N or less.
